(19) United States
(12) Patent Application Publication
(10) Pub. No.: US 2001/0005469 A1
(43) Pub. Date: Jun. 28, 2001

(54) Structure for mounting a garnish in an automobile

(76) Inventor: Jong Kweon Pyun, Suwon (KR)

Correspondence Address: CHRISTIE, PARKER & HALE, LLP, P.O. Box 7068, Pasadena, CA, 91109-7068, US

(21) Appl. No.: 09/753,248

(22) Filed: Dec. 27, 2000

(30) Foreign Application Priority Data
Dec. 27, 1999 (KR) 1999-62996

(51) Int. Cl. F16B 1/00

(52) U.S. Cl. 403/217

(57) ABSTRACT

The present invention relates to a structure for mounting a garnish in an automobile that can prevent the garnish from coming off from a body panel. In the structure for mounting the garnish of the present invention, a bracket having elasticity is mounted to a rear surface of the garnish so that it is possible to maintain the mounting state between the garnish and the body panel.

### BACKGROUND OF THE INVENTION

1. Field of the Invention

The present invention relates to a structure for mounting a garnish in an automobile and more particularly, to the structure for mounting a garnish in an automobile comprising a bracket which can securely maintain a mounting state with a garnish which is an accessory mounted to a side portion of an automobile.

2. Information Disclosures Statement

Generally, a garnish for an automobile is a kind of accessory and mounted to a certain portion of an outer panel of the automobile. Examples include a garnish for number plate for covering a mounting portion located on an upper portion of a mounting plate of a trunk lid and a side garnish installed on a line adjacent to a wheel of a fender for enhancing appearance.

In FIG. 3 which is a sectional view showing a mounting state of the conventional side garnish, a rib 22 for fixing a clip is formed integrally with a rear surface of the garnish and is extruded, and one touch type clip 20 is attached to the rib 22. Thus, the clip 20 is inserted in a desired portion of the panel in one touch manner so that the garnish is mounted completely.

In the conventional structure for mounting the garnish as described above, however, there are some drawbacks as follows.

Since the garnish 10 is locked and fixed to the body panel 16 by the clip 20 only, a gap is existed at A portion as shown in FIG. 3, that is, the upper portion of the garnish 10 comes off from the body panel 24. Furthermore, when a locking force of the clip 20 be weaken, the above gap between the upper portion of the garnish 10 and the body panel 24 becomes wider so that a locking condition of the garnish 10 becomes worse.

### SUMMARY OF THE INVENTION

Therefore, an object of the present invention is to provide a structure for mounting a garnish on an automobile that can solve problems as mentioned above.

In the structure for mounting the garnish of the present invention, a bracket which has elasticity and is capable of supplying a force for contacting the upper portion of the garnish firmly with a body panel is mounted to a rear surface of the garnish so that a mounting state of the garnish to the body panel can be maintained securely.

### BRIEF DESCRIPTION OF THE DRAWINGS

For fuller understanding of the nature and objects of the invention, reference should be had to the following detailed description taken in conjunction with the accompanying drawings in which:

FIG. 1 is a sectional view showing an embodiment of the structure for mounting a garnish on an automobile.

FIG. 2 is a sectional view showing another embodiment of the structure for mounting a garnish on an automobile.

FIG. 3 is a sectional view showing a conventional structure for mounting a garnish on an automobile.

Similar reference characters refer to similar parts throughout the several views of the drawings.

### DETAILED DESCRIPTION OF THE INVENTION

The present invention is characterized by a garnish 10 comprising a bracket 12 having an opening portion 18 at a central portion thereof and a bending portion 24 at a lower portion thereof, wherein the opening portion 18 of the bracket 12 is contacted with a mounting portion 14 on a rear center of the garnish 10 firmly by a screw, and then a lower end of the garnish 10 and a lower end of the bracket 12 contacted with from each other are mounted to a body panel 16 by a rivet to contact securely an upper portion of the garnish 10 with a body panel 16 by elasticity acted toward the body panel 16 from the bending portion 24.

Specially, a clip 20 is mounted between an upper portion and a middle portion of the bracket 12 fixed to the mounting portion 14 of the garnish 10 and the clip 20 is mounted to the body panel 16.

Hereinafter, the present invention having characteristics as described above will be described in greater detail as an embodiment taken in conjunction with the accompanying drawings

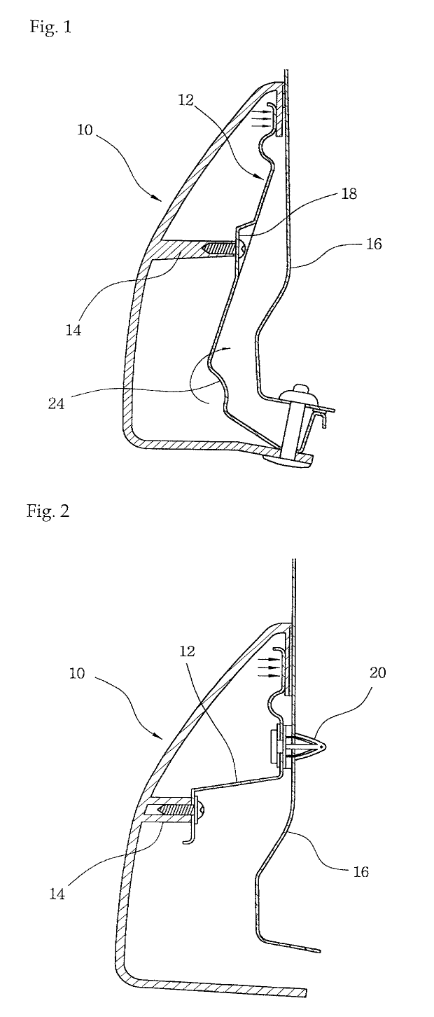

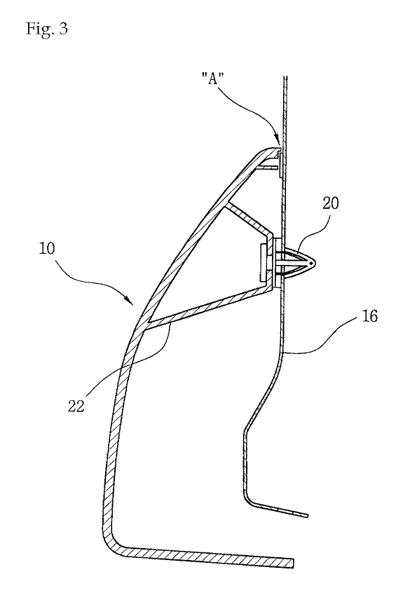

FIG. 1 is a sectional view showing the structure for mounting a garnish in an automobile according to the present invention, a reference numeral 12 is a bracket.

The bracket 12 is extended and inclined slightly from the upper end and a lower portion is bent with an obtuse angle. This curved portion at the lower portion is the bending portion 24.

Also, an opening portion 18 is formed vertically at a center portion of the bracket 12 and a fixing hole for mounting is formed at the opening portion 18.

Another curved portion having a semicircle shape is formed at an upper portion of the bracket 12 to support elastic force of the bending portion 24 of the bracket 12.

The opening portion 18 of the bracket 12 having a structure as described above is contacted with the mounting portion 14 formed on a rear center portion of the garnish 10, and they are firmly fixed by a screw.

Also an inner surface of a lower end of the garnish 10 and a lower end of the bracket 12 are contacted with from each other and mounted to the body panel 16 by a rivet from an outer surface of the garnish 10 to the body panel 16.

At this time, the elasticity of the upper end portion of the bracket 12 acts toward the body panel 16, therefore an upper end of the garnish 10 is pushed toward the body panel by the elasticity of the bracket 12 as shown in FIG. 1.

Consequently, the lower end of the garnish 10 is fixed to the body panel 16 by the rivet and the upper end of the garnish 10 is contacted securely to the body panel 16 by the elasticity of the bracket 12 generated from the bending portion 24.

As shown in FIG. 2 which is a sectional view showing another embodiment of the structure for mounting a garnish in an automobile, a bracket 12 of this embodiment differs from the bracket of the previous embodiment in shape. The bracket 12 does not have a lower portion extended to a lower end of the garnish 10 as shown in FIG. 1 and has the first and second bending portions. A clip 20 is locked at a rear upper portion of the bracket 12.

The lower portion of the bracket 12 is secured to the mounting portion 14 of the garnish 10 by the screw, and the clip 20 is combined with the body panel 16. Therefore, the garnish 10 is mounted to the body panel 16 by the clip 20 at upper portion of the garnish 10 so that the upper portion of the garnish 10 does not come off from the body panel 16.

In the structure for mounting the garnish in an automobile according the present invention, the bracket having elasticity is mounted to a rear surface of the garnish to contact firmly the upper portion of the garnish with the body panel. Consequently, the present invention can prevent the upper portion of the garnish from coming off from the body panel and maintain securely the mounting state between the garnish and the body panel.

Although this invention has been described in its preferred form with a certain degree of particularity, it is appreciated by those skilled in the art that the present invention disclosure of the preferred form has been made only by way of example and that numerous changes in the details of the construction, combination and arrangement of parts may be resorted to without departing from the spirit and scope of the invention.

What is claimed is

1. A structure for mounting a garnish in an automobile comprising a bracket having an opening portion at a central portion thereof and a bending portion at a lower portion thereof to fix firmly a lower portion of the garnish and a lower portion of the bracket with a body panel by a mounting means.

2. The structure for mounting a garnish on an automobile of claim 1, wherein said bending portion acts for the upper portion of the bracket to provide elasticity toward the body panel to contact therewith firmly.

3. The structure for mounting a garnish on an automobile of claim 1 or claim 2, wherein the upper portion of the garnish, where the upper portion of said bracket is inserted, is also contacted firmly with the body panel by elasticity generated from said bending portion.

4. The structure for mounting a garnish on an automobile of claim 1, wherein said mounting means to fix firmly a low portion of the garnish and a low portion of the bracket with a body panel is a rivet.

5. The structure for mounting a garnish on an automobile of claim 1, wherein said opening portion of the bracket is contacted firmly with a mounting portion of the garnish by fixing with a screw.

6. The structure for mounting a garnish on an automobile of claim 1, wherein said opening portion of the bracket is fixed firmly with a mounting portion mounted at the rear center portion of the garnish by a clip.
